(19) United States
(12) Patent Application Publication
(10) Pub. No.: US 2009/0268045 A1
(43) Pub. Date: Oct. 29, 2009

(54) APPARATUS AND METHODS FOR CONFIGURATION AND OPTIMIZATION OF IMAGE SENSORS FOR GAZE TRACKING APPLICATIONS

(76) Inventors: Sudipto Sur, San Diego, CA (US); Luis M. Pestana, San Diego, CA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/185,752

(22) Filed: Aug. 4, 2008

Related U.S. Application Data
(60) Provisional application No. 60/953,679, filed on Aug. 2, 2007.
(60) Provisional application No. 60/955,639, filed on Aug. 14, 2007.
(60) Provisional application No. 60/957,164, filed on Aug. 21, 2007.
(60) Provisional application No. 61/021,945, filed on Jan. 18, 2008.
(60) Provisional application No. 61/040,709, filed on Mar. 30, 2008.

(51) Int. Cl. H04N 5/228; G06K 9/40

(52) U.S. Cl. 348/222.1; 382/260

(57) ABSTRACT

Apparatus and methods for enhancing the performance of an imager in applications such as gaze tracking are described. An enhanced image sensor includes a sensor pixel array, a filter array optically coupled to the pixel array and a filter map including data associated with one or more characteristics of the filter array. The filter array characteristics can be preconfigured and/or dynamically reconfigured to allow for wavelength specific pixel capture, with the filter map correspondingly adjusted in response to changes in the filter array characteristics.

### CROSS-REFERENCE TO RELATED APPLICATIONS

This application claims priority under 35 U.S.C. §119(e) to co-pending U.S. Provisional Patent Application Ser. No. 60/953,679, entitled OPTIMIZATION OF IMAGES SENSORS FOR USE IN GAZE TRACKING APPLICATIONS, filed on Aug. 2, 2007. This application is related to U.S. Provisional Patent Application Ser. No. 60/955,639, entitled APPLICATIONS BASED ON GAZE TRACKING INTEGRATED WITH OTHER SENSORS, ACTUATORS AND ACTIVE ELEMENTS, filed on Aug. 14, 2007, to U.S. Provisional Patent Application Ser. No. 60/957,164, entitled SYNCHRONIZATION OF IMAGE SENSOR ELEMENT EXPOSURE AND ILLUMINATION FOR GAZE TRACKING APPLICATIONS, filed on Aug. 21, 2007, to U.S. Provisional Patent Application Ser. No. 61/021,945, entitled APPARATUS AND METHODS FOR SPATIAL REGISTRATION OF USER FEATURES IN GAZE TRACKING APPLICATIONS, filed Jan. 18, 2008, to U.S. Provisional Patent Application Ser. No. 61/040,709, entitled APPARATUS AND METHODS FOR GLINT SIGNAL OPTIMIZATION AND SPATIAL REGISTRATION, filed on Mar. 30, 2008, to. U.S. Utility patent application Ser. No. 12/139,369, entitled PLATFORM AND METHOD FOR CLOSED-LOOP CONTROL OF ILLUMINATION FOR GAZE TRACKING APPLICATION, filed on Jun. 13, 2008, and to U.S. Utility patent application Ser. No. 12/025,716, entitled GAZE TRACKING USING MULTIPLE IMAGES, filed on Feb. 4, 2008. The content of each of these applications is hereby incorporated by reference herein in its entirety for all purposes.

### FIELD OF THE INVENTION

The present invention is related generally to gaze tracking systems and methods. More particularly but not exclusively, the present invention relates to apparatus and methods for enhancing the performance and response of imaging sensors used for gaze tracking applications by combining pixel specific filtering with sensor elements to facilitate image processing.

### BACKGROUND

In typical imaging applications, an imaging device (also denoted herein as an imager) is used to capture digital images based on light focused on or incident on a photosensitive element of the device. Digital imaging devices utilize photoelectronic imaging sensors consisting of arrays of pixels. Photoelectronic sensors used in many applications are based on semiconductor technologies such as Charge-Coupled Device (CCDs) and Complementary Metal-Oxide-Semiconductor (CMOS). While standard implementations of these imaging sensors are suitable for many applications, the pixel arrays associated with standard imaging devices are typically homogeneous, having the same imaging and photosensitivity characteristic throughout the sensor.

In some applications, it may be desirable to have additional control over pixel-specific characteristics of the imaging sensor and/or over associated pixel-specific processing. Accordingly, there is a need in the art for imaging devices that provide more pixel-specific configurations and controls.

### SUMMARY

The present invention is related generally to gaze tracking systems and methods.

In one aspect, the present invention is directed to a filtering assembly for an imaging apparatus comprising a filter array including a plurality of filter elements, said plurality of filter elements including a first filter element configured to filter light according to a first range of wavelengths and a second filter element configured to filter light according to a second range of wavelengths and a filter map, said filter map including a set of data corresponding to characteristics of ones of the plurality of filter elements.

In another aspect, the present invention is directed to an imaging apparatus comprising an imaging sensor having a plurality of pixel elements disposed in an array, said pixel elements configured for sensing light, a filter array optically coupled to the pixel array, said filter array including a plurality of filter elements matched to ones of a corresponding plurality of the pixel elements and a filter map, said filter map including a set of data corresponding to ones of the plurality of filter elements.

In another aspect, the present invention is directed to a method of processing images for gaze tracking applications comprising receiving a first set of data representing sensor data provided by ones of a plurality of sensor elements of a pixel array, receiving a filter map, said filter map including data associated with characteristics of ones of a plurality of filter elements associated with corresponding ones of the plurality of sensor elements and generating a first processed image, said processed image generated at least in part by adjusting the first set of data based on the filter map.

Additional aspects of the present invention are further described and illustrated herein with respect to the following detailed description and appended drawings.

### BRIEF DESCRIPTION OF THE DRAWINGS

For a better understanding of the nature of the features of the invention, reference should be made to the following detailed description taken in conjunction with the accompanying drawings, in which:

FIG. 1 illustrates a gaze tracking system on which embodiments of the present invention may be implemented.

FIG. 2a illustrates details of an embodiment of an imager, in accordance with aspects of the present invention.

FIG. 2b illustrates details of an embodiment of an image sensor, in accordance with aspects of the present invention.

FIG. 3a illustrates details of embodiments of image sensor filtering element configurations, in accordance with aspects of the present invention.

FIG. 3b illustrates details of an enhanced image sensor including a pixel array sensor and a filter array, in accordance with aspects of the present invention.

FIG. 3c illustrates details of embodiments of a filter array in accordance with aspects of the present invention.

FIG. 4 illustrates details of an embodiment of a process for adjusting image data acquired from an image sensor, in accordance with aspects of the present invention.

FIG. 5a illustrates details of an embodiment of a process for sub-image enhancement, in accordance with aspects of the present invention.

FIG. 5b illustrates details of embodiments of sub-images and sub-image enhancement, in accordance with aspects of the present invention.

FIG. 6 illustrates an embodiment of an image sensor filtering configuration, in accordance with aspects of the present invention.

FIG. 7 illustrates details of an embodiment of IR response enhancement, in accordance with aspects of the present invention.

### DETAILED DESCRIPTION OF EMBODIMENTS OF THE INVENTION

This application is related to U.S. Provisional Patent Application Ser. No. 60/955,639, entitled APPLICATIONS BASED ON GAZE TRACKING INTEGRATED WITH OTHER SENSORS, ACTUATORS AND ACTIVE ELEMENTS, to U.S. Provisional Patent Application Ser. No. 60/957,164, entitled SYNCHRONIZATION OF IMAGE SENSOR ELEMENT EXPOSURE AND ILLUMINATION FOR GAZE TRACKING APPLICATIONS, to U.S. Provisional Patent Application Ser. No. 61/021,945, entitled APPARATUS AND METHODS FOR SPATIAL REGISTRATION OF USER FEATURES IN GAZE TRACKING APPLICATIONS, to U.S. Provisional Patent Application Ser. No. 61/040,709, entitled APPARATUS AND METHODS FOR GLINT SIGNAL OPTIMIZATION AND SPATIAL REGISTRATION, to U.S. Utility patent application Ser. No. 12/139,369, entitled PLATFORM AND METHOD FOR CLOSED-LOOP CONTROL OF ILLUMINATION FOR GAZE TRACKING APPLICATION, and to U.S. Utility patent application Ser. No. 12/025,716, entitled GAZE TRACKING USING MULTIPLE IMAGES. The content of each of these applications is hereby incorporated by reference herein in its entirety for all purposes. These applications may be denoted collectively herein as the “related applications” for purposes of brevity.

### OVERVIEW

The present invention is related generally to gaze tracking systems and methods. More particularly but not exclusively, the present invention relates to apparatus and methods for enhancing the performance and response of imaging sensors used for gaze tracking applications.

Embodiments of various aspects of the present invention are further described below with respect to the appended drawings. It is noted that the embodiments described herein are provided for purposes of illustration, not limitation, and other embodiments including fewer components or stages, more components or stages and/or different components or stages are fully contemplated within the spirit and scope of the present invention.

Various embodiments of the present invention are described in detail below with reference to the figures, wherein like elements are referenced with like numerals throughout unless noted otherwise.

Gaze tracking systems are used to measure and track the relative position of a user's attention when viewing a reference component, such as a computer display screen or other point of interest. The relative position of the user is typically determined with respect to a particular frame of reference, which then allows for tracking of the user's gaze and/or other user related parameters, including those described herein and in the related applications. For example, in a gaze tracking application for use on a computer system, the most relevant frame of reference would typically be the computer's display or monitor, and the user's gazing direction may be determined by generating images of the user, and in particular user features such as the eyes and reflections from the eyes (i.e., glints), and then determining gaze from those images. A core component of such a system are imaging devices, which are components for receiving and capturing images of the user. The present invention is directed to apparatus and methods for enhancing the configuration and performance of imaging devices to increase overall system performance in applications such as gaze tracking, as well as other applications.

### DESCRIPTION OF EMBODIMENTS

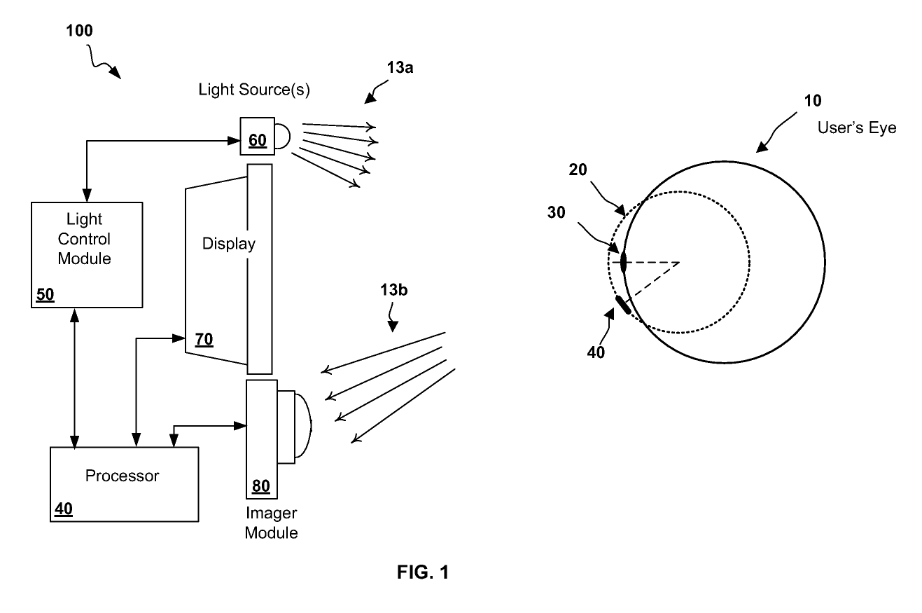

Attention is now directed to FIG. 1, which illustrates a generalized view of a system 100 configured to facilitate embodiments of the present invention for use in gaze tracking of a target object (such as a user's eye 10). The user's eye 10 may be gazing at an image on display 70, or at another object or point of interest in alternate implementations, with the gaze tracking system tracking the eye's position and/or movement. For example, eye movement may be tracked for applications such as visual user interfaces to a computer system, or for medical research or testing. System 100 includes a light source or sources 60, typically configured to generate one or more controlled (in intensity, position and/or time) light beams 13a directed to the target object (i.e., the user's eye 10 or another target). Additional light sources (not shown) may also be included in system 100, such as separate light sources for user registration, as are described in the related applications, and/or separate light sources for emitting light at different wavelengths (such as visible light and infra-red (IR)). Light source 60 is typically configured to generate a glint 40 (i.e., a corneal reflection, from the cornea 20) at the user's eye 10. Additional targeted features may include the pupil 30 and/or other features of the user's eye or face (or other target features in alternate implementations).

Light source 60 may include fixed or dynamically adjustable elements for generating and controlling light illumination, typically at IR wavelengths, but also, in some embodiments, at visible or other wavelengths. The output light from source 60 may be modulated in amplitude, may be time varying, such as by turning light output on and off, may be adjusted by wavelength, and/or may be adjusted by position or rotation. In some embodiments two or more light sources 60 may be combined in a single component source or module to provide multiple light output functionality.

In a typical gaze tracking application, output light 13a is generated by light source 60 and reflected from features of the eye 10, with the reflected light as well as any ambient or other light (incoming sensor light 13b) received at imager module 80. Imager module 80 includes one or more imaging sensor elements configured to capture incoming light and generate one or more images for further processing in processor module 40. Imager module 80 may also include optical elements such as lenses and associated mechanical assemblies, filters, mirrors, electronics, processors, embedded software/firmware and/or memory, as well as housings and/or other related electronic or mechanical components.

Processor module 40 is configured to receive one or more images from imager module 80 to generate user tracking data as well as provide data to light control module 50 to adjust the output of light source(s) 60 to optimize tracking or feature recognition performance. Processor module 40 may also be connected to display 70 to provide on-display images from the target object, such as cursors or other indications of the user's point of regard and/or other displays or information. It is noted that the processing and control functionality illustrated in FIG. 1 may be implemented by one or more external systems, such as an external personal computer or other computing device or processor system (such as embedded systems).

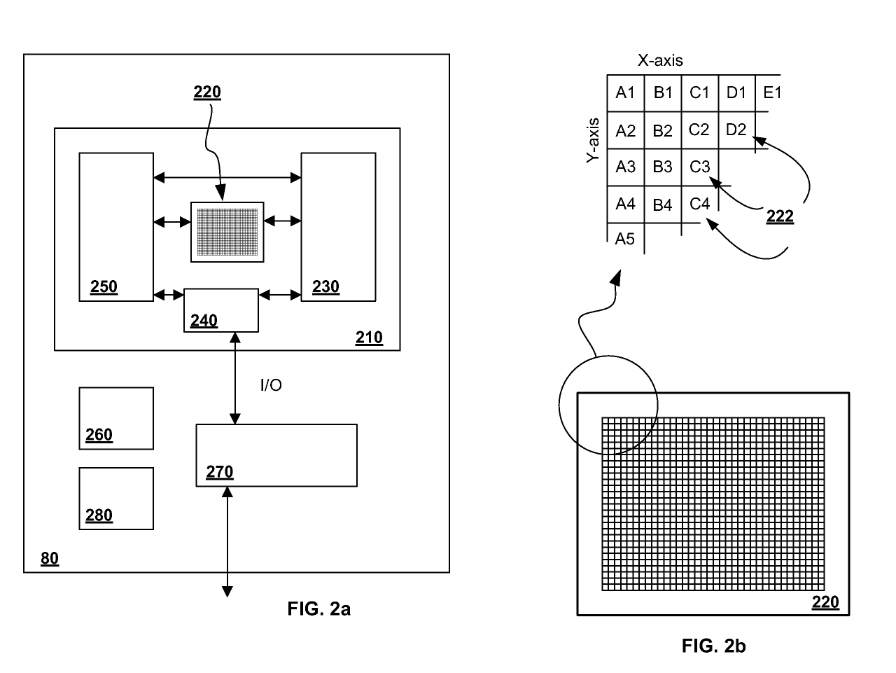

Attention is now directed to FIG. 2a, which illustrates details of an embodiment of an imager 80, in accordance with aspects of the present invention. As shown in FIG. 2a, imager 80 may include multiple components, including an imaging sensor element 210, imager electronics 270, mechanical components 260, optical components 280, and/or other components not specifically illustrated in FIG. 2a. Imaging sensor element 210 may include one or more components as shown in FIG. 1. In particular, imaging sensor element 210 includes an image sensor (also denoted for brevity as “sensor”) 220, as well as, in some embodiments, other elements such as sensor element analog electronics 230, sensor element digital electronics 250, a sensor element I/O interface 240, as well as mechanical elements, optical elements (such as filters) and/or other related elements (not shown). Analog electronics 230 may be used to condition or process signals from sensor 220, and/or for other functions, such as driving sensor 220 and performing analog to digital conversion on signals received from sensor 220. Digital electronics 250 may include components for receiving, storing and/or processing images generated by sensor 220, and/or for storing data related to the sensor 220, such as pixel calibration data, filter data, mask data, application data and/or other data or information. In addition, digital electronics may include one or more processor and associated digital processing elements for performing processing of received raw data from sensor 220.

Additional details of sensor 220 are illustrated in FIG. 2b. In a typical embodiment, sensor 220 includes an array of pixel elements 222 (also denoted herein as “pixels”) configured to receive incoming light, typically focused by a lens assembly of imager 80, and generate a corresponding electrical signal representative of the received light signal. Commonly used sensors are based on CMOS or CCD technology, however, other sensor technologies known or developed in the art may also be used in some embodiments. For purpose of illustration, the pixels 222 may be described in terms of an X-Y grid as shown in FIG. 2b, with the pixels 222 assigned names based on coordinate values (as shown, with X values denoted by letters and Y values denoted by numbers).

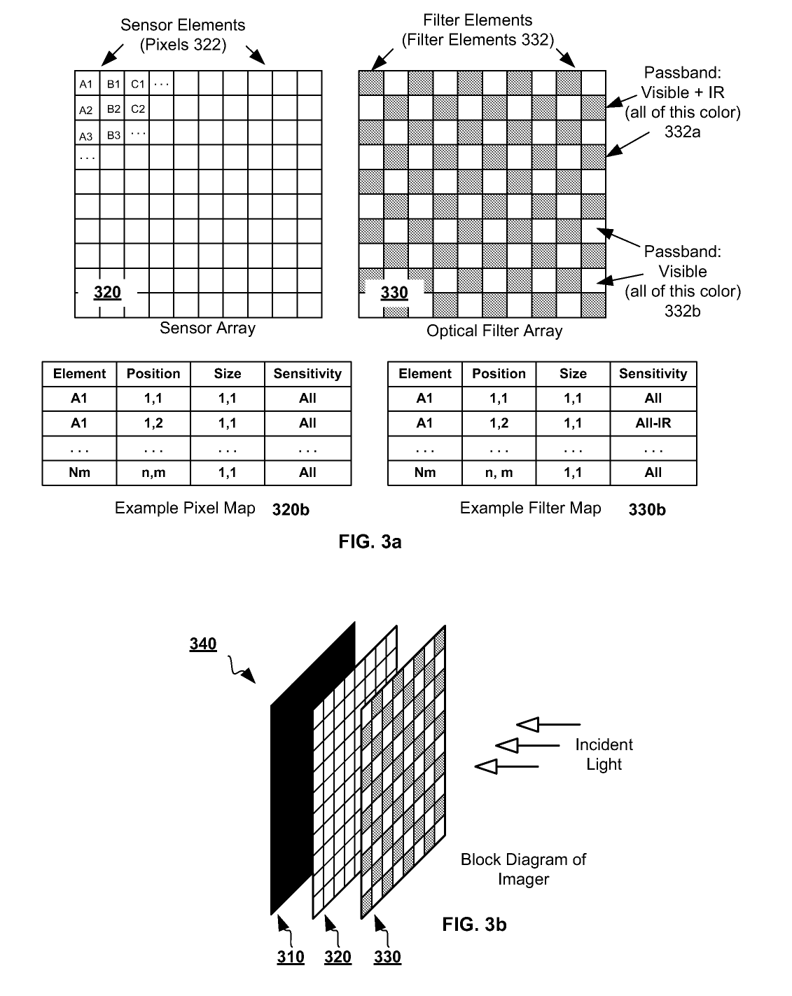

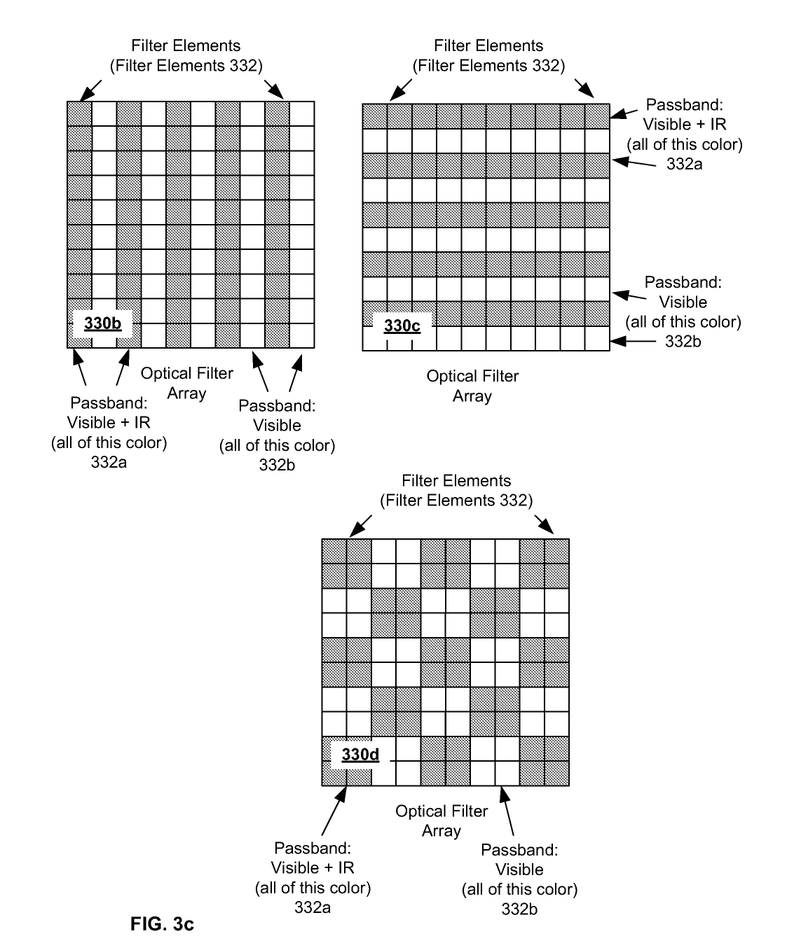

In accordance with one aspect of the present invention, a set of filter elements 332 may be applied to the sensor pixels of a sensor array 320 in combination with a substrate 310, as shown in FIG. 3b, to facilitate mapping and filtering of the pixel array. Sensor array 320 illustrates an example pixel array, such as might be included in sensor 220. In typical embodiments, sensor array 320 is a two dimensional homogenous array arranged on a substrate (such as, for example, in a 640×480 array, an 800×600 array, a 1280×1024 array or in another array configuration), however, this is not strictly required. For example, the pixel array may be constructed so that the various pixels have different characteristics, are non-planar, are rectangular or have other shapes, and the like. In particular, the pixels may vary in response to different wavelengths and amplitudes of incident light, linearity, gain and/or other characteristics such as shape, size and/or arrangement.

Particular characteristics of the pixels 322 of sensor array 320 may be determined and mapped into a pixel map 320b, with characteristics or parameters associated with one or more pixels 322 (typically all pixels 322) of sensor array 320 stored in the pixel map 320b as shown in FIG. 3a. For example, in the embodiment as shown in FIG. 3a, pixel map 320b includes data describing the pixel element name or ID, position in the array, size, sensitivity, or other characteristics, such as calibration or correction offsets or other data associated with the particular pixel 322. The pixel map data may be stored in memory in the imager or sensor element, such as in element 250 as shown in FIG. 2a, or may be stored externally to the sensor element or imager. In addition, the pixel map 320b may be segregated so that some pixel characteristics are stored in one memory location and others are stored in another (such as in separate files, in separate memory devices or types of memory, etc.). In general, any modality which allows creation, storage and access of pixel data from pixel map 320b may be used. In some embodiments, characteristics associated with the pixels 322 of sensor array 320 may be dynamically adjusted during operation of the sensor element. For example, specific pixels of groups of pixels may be configured for dynamic adjustment of pixel characteristics, including gain, wavelength sensitivity or other pixel characteristics. For example, pixel gain (and corresponding sensitivity) may be adjusted on a pixel-by-pixel basis in some embodiments. This information may then be updated dynamically in pixel map 320b based on the current value of the particular parameter. The adjusted pixel map values may then be used in further processing to provide a dynamic, time-adjusted input related to specific sensor pixel characteristics.

In addition, a filter array 330, matched to the sensor array 320, may be included in the sensor element. The filter array 330 may also be denoted herein as a Gaze Tracker Filter Array, abbreviated as a GTFA. As shown in FIG. 3a, filter array 330 includes a set of filter elements 332, with the filter elements 332 typically being configured to provide different filtering characteristics to one or more pixels 322 of array 320. Filter elements 332 are objects that are configured to modify the response to incident light received by the various pixels 322. These include elements to attenuate certain received wavelengths (such as optical filters), either statically or dynamically, by insertion between the incident light source and the pixel 322. In addition, filter elements 332 may comprise electronic components and algorithmic elements (implemented in, for example, software, firmware or hardware), which may be used to filter, either statically or dynamically, raw electronic output from the pixels 322. In addition, each filter element 332 may have different characteristics. In embodiments where optical filters are used, characteristic data associated with the filter element may include transmissivity of the filter as a function of wavelength, polarization, position in the filter array and/or other optical, electrical, mechanical or positional characteristics of the filter element.

For example, as shown in FIG. 3a, filter elements 332 may be distributed in a checkerboard pattern, with adjacent elements configured to filter different bands of light. The darker filter elements 332a are configured to pass light in visible as well as infra-red (IR) wavelengths, whereas the lighter filter elements 332b are configured to pass light only in visible wavelengths. This configuration may be used for applications where the relative features sizes are large, and the adjacent pixels of simultaneously acquired images can be processed by discarding every other pixel, interpolating every other pixel, or by other processing methods, to simultaneously generate a visible light image and a visible light plus IR image, which may then be combined, such as by subtraction, to enhance IR features of the target object. It is noted that, in some filter embodiments, the transmissivity characteristics of the wavelength specific filter elements 332a and 332b may be selected so that the wavelengths of light passed by filter elements 332a and 332b are substantially non-overlapping, thereby minimizing common wavelength transmissivity.

A variety of other filter array pixel configurations may also be used. For example, FIG. 3c illustrates embodiments of optical filter arrays 330b and 330c having row and column specific filter configurations, respectively. FIG. 3c also include optical filter array 330d, which has 4×4 array filtering. In some embodiments the filtering configuration may be non-symmetric and/or may have more filter elements of one particular type. For example, in some embodiments more filter elements including IR sensitivity may be included, whereas, in some embodiments more filter elements having visible light only sensitivity may be included. It is noted that the particular filter element configurations as shown in FIGS. 3a and 3c are examples provided for purposes of illustration, and in some embodiments other configurations may alternately be used, such as providing filter elements with more than two passband characteristics, other patterns beyond those shown in FIGS. 3a, 3c and 3d, or having other filter array characteristics, such as dividing the sensor array and filtering by regions, using larger or smaller filter elements, or by using other configurations.

In addition, in some embodiments the characteristics of the filter array may be dynamically alterable based on particular image, spatial, temporal and/or other characteristics of the image received from the target object and/or from information provided by a processor such as processor 40, via a filter control signal (not shown), or by another processor or other component of imager 80 or system 100. For example, in one embodiment the filter array may include LCD elements (or other elements known or developed in the art) configured to allow dynamic adjustment of filter characteristics such as intensity, polarization and/or passed or attenuated wavelengths based on the provided control signal. Data associated with this dynamically adjustable information may then be provided, typically simultaneously, to an associated filter map 330b as further described below.

GTFA 330 also includes a filter map 330b as shown in FIG. 3a. Filter map 330b may be configured in a fashion similar to pixel map 220b, with element names, positions, and/or sizes included in the filter map data. Sensitivity data or other characteristics or parameters associated with the filter elements 332 of filter map 330b may be provided as shown in FIG. 3a, with the alternating ALL and ALL-IR (or visible only) sensitivity stored as shown. In some embodiments, pixel map 320b and filter array 330b may be a shared map including shared data. In addition, as noted previously, GTFA 330 may be dynamically updatable, with the corresponding filter map 330b information also dynamically updated in response to dynamic changes in the characteristics of GTFA 330.

As noted previously, In typical embodiments, GTFA 330 comprises a one dimensional or multi-dimensional mosaic pattern of filter elements 332, where the filter elements 332 modify the spectral response of corresponding pixel elements of the sensor array 320. In some embodiments, GTFA 330 may be constructed in a filter-on-window configuration, which is a manufacturing method allowing placement of filter elements onto the window of a sensor, such as sensor 320. This may be done with CCD or CMOS sensors, as well as with other sensor elements. Alternately, in some embodiments, GTFA 330 may be constructed using a filter-on-die configuration, which is a manufacturing method wherein the filtering elements are placed directly onto the silicon surface of the sensor (such as the CCD or CMOS sensor).

In some embodiments, GTFA 330 may be a separate component, such as in a filter-on-window implementation, or may be integral with the sensor 320, such as in a filter-on-die implementation. As a separate component, GTFA 330 is aligned and mated to the sensor 320, such as through mechanical alignment and mounting techniques as are know or developed in the art. In some embodiments, GTFA 330 may be constructed of passive, discrete optical filter elements. Each passive filter element may have different optical absorptive properties. Alternately, GTFA 330 may be constructed with one or more active elements, which may be addressable and programmable, such as in conjunction with digital electronics element 250 of FIG. 2a, and/or in conjunction with a processor such as processor 40 or other processors on sensor element 210 or imager 80. For example, GTFA may include one or more LCD elements aligned and mated to the sensor 320 with matching characteristics, such as pixel count, dimensions and the like. GTFA 330's filter map 330b may match pixel map 320b or may include different data. Pixel map 320b and/or filter map 330b may be stored in the firmware or software on imager 80, and/or in an external memory.

As an integral component of sensor 320 (i.e., in a filter-on-die configuration), GTFA 330 may have a filtering pattern construction based on known fabrication technologies for manufacturing filter arrays. For example, a Bayer Color Filter Array (BCFA) implementation may be used, where the BCFA is a mosaic pattern consisting of a single wavelength of filter elements (such as red, green and blue), which is commonly used for capturing and reconstructing color images. In addition, the GTFA 330 filter elements may be constructed by controlling and/or modifying the inherent optical reflectivity and transmissive properties of silicon during pixel sensor 320 manufacturing. The QE of an imager's pixel cavity at wavelengths of interest may be controlled accordingly.

GTFA 330 elements may also be constructed by controlling the placement of optical dead structures and/or modifying the absorption losses within an imager's pixel cavity. The QE of an imager's pixel cavity at wavelengths of interest may be controlled accordingly. The GTFA 330 elements may also be constructed by doping the corresponding imager's pixel cavity (such as, for example, by using ion implantation techniques) to create different optical absorptive properties.

FIG. 3b illustrates a composite sensor 340 including sensor array 320 combined with filter array 330 and a substrate 310. Composite sensor 340 may be used in applications as sensor 220 as shown in FIGS. 2a and 2b. In processing data provided by sensor 340, data contained in a pixel map 320b, associated with a raw sensor array 320, and/or data contained in the filter map 330b, associated an optical filter array 330 may be used to facilitate image processing as is further described below.

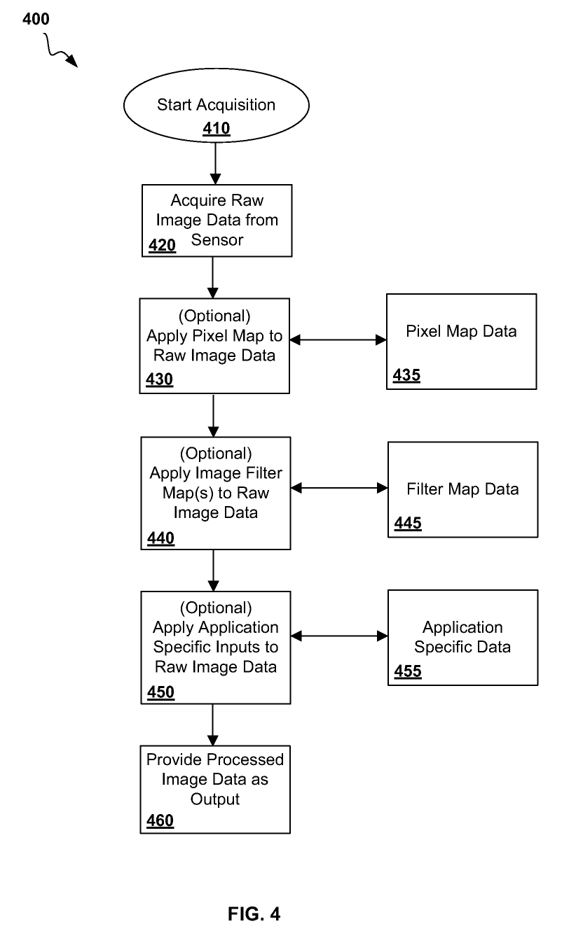

Images obtained from a filtered sensor, such as sensor 340, may then be processed as illustrated in processing embodiment 400 of FIG. 4 to apply the pixel map data and/or the filter map data to the raw image provided by sensor array 220 to enhance performance of the gaze tracking (or other) system. It is noted that process 400 as illustrated in FIG. 4 includes particular stages, however, these stages are provided for purposes of illustration, not limitation. Other processes having fewer, more and/or different stages than those shown in FIG. 4 may alternately be used in some embodiments.

Process 400 begins with a start acquisition stage 410, where image acquisition may be triggered by the processor 40 in conjunction with light source 60. For example, processor 40, in conjunction with control module 50, may direct light source 60 to provide IR light (and/or visible or other wavelengths of light) to the user's eye 10 as shown in FIG. 1. A raw image of the user's face that may include the IR light provided by light source 60 and/or visible or other light, as well as any other ambient light, may be generated by sensor array 220 at stage 420, with any corresponding pixel map data 435 optionally applied to the raw image data at stage 430 to adjust the acquired image pixels in correspondence to the pixel map. Any corresponding filter map data 445 may optionally be applied to the raw or pixel processed image data at stage 440 to further adjust for filter characteristics associated with filter array 330. In addition, any application specific data 455 may be applied to the pixel and/or filter processed image data at stage 450 to generate enhanced image data that may then be provided to processor 40 and/or to other processing systems, such as external computers or embedded devices.

For example, in some embodiments specific processing is dependent on the particular sensor and filter array 330 and filter map data 330b. In one embodiment, a pattern composed of blue, green, red (for color imaging) and IR filters may be used in a 2×2 matrix, with the green signal value doubled to allow chromatic reconstruction of the scene in a standard implementation. Alternately, if alternate rows are comprised of IR filters, one row may be subtracted from the adjacent row to obtain the IR response. In addition, it is noted that the above described processing may be implemented in a fashion that is different from that used in conventional imaging applications where chromatic and spatial reconstruction are desired. In many embodiments of the present invention, the acquired images and associated processing are not ultimately intended for direct display to an end user, as is the case with a conventional imaging system, but rather is typically used to provide information such as gazing direction data and associated motion or tracking data.

It is noted that the processing described with respect to FIG. 4 may be performed in whole or in part in electronics on the sensor element 210, such as digital electronics 250 as shown in FIG. 2a, and/or may be performed in whole or in part in processor 40 and/or on an external computer or embedded system. The processing may be implemented on a general purpose processor and/or may be implemented with a special purpose device such as a DSP, ASIC, FPGA or other programmable device.

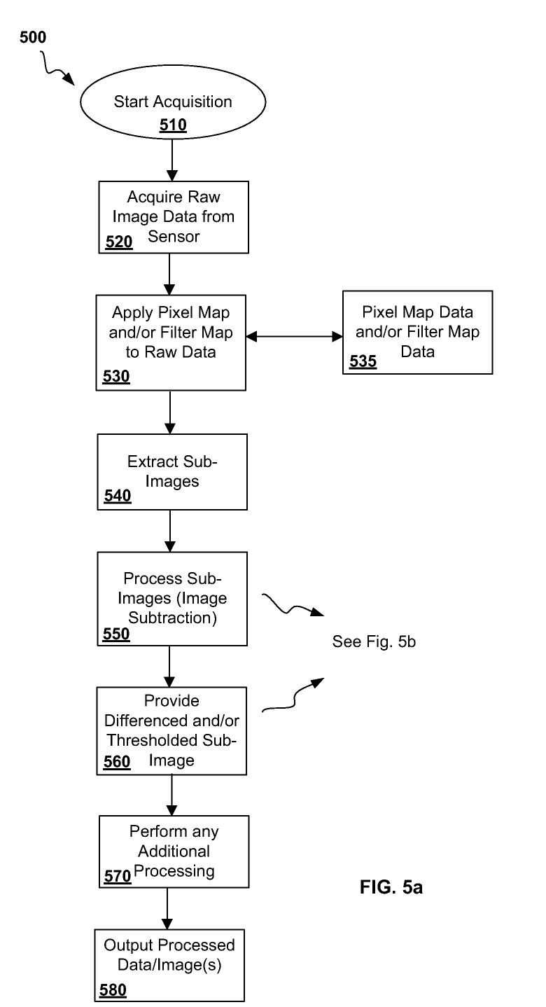

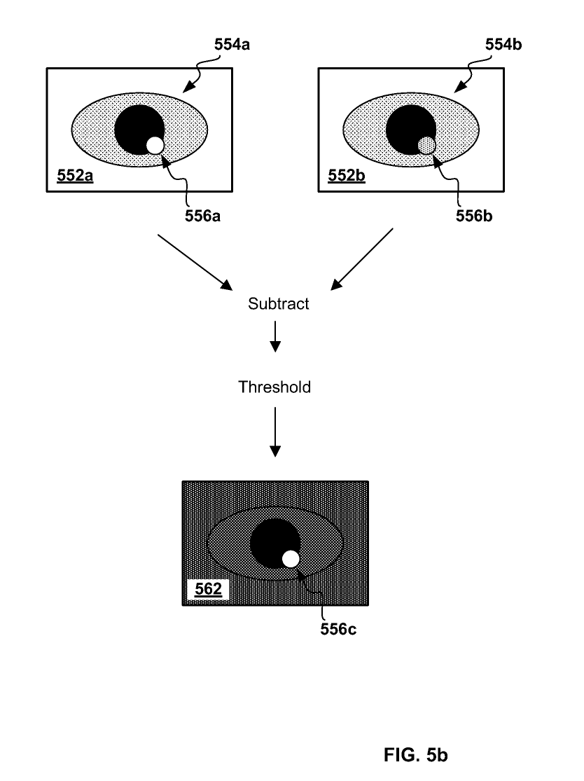

FIG. 5 illustrates details of an embodiment of a process 500 in accordance with aspects of the present invention for enhancement of a glint (i.e., corneal reflection), or other wavelength specific feature, for use in gaze tracking applications. It is noted that process 500 as illustrated in FIG. 5 includes particular stages, however, these stages are provided for purposes of illustration, not limitation. Other processes having fewer, more and/or different stages than those shown in FIG. 5 may alternately be used in some embodiments.

Process 500 begins with a start acquisition stage 510, where image acquisition may be triggered by the processor 40 in conjunction with light source 60. For example, processor 40, in conjunction with control module 50, may direct light source 60 to provide IR light (and/or visible or other wavelengths of light) to the user's eye 10 as shown in FIG. 1, to generate a glint 40 and pupil 50 illumination. A raw image of the user's face that may include the IR light provided by light source 60 and/or visible or other light, as well as any other ambient light, may be generated by sensor array 220 at stage 520. Corresponding pixel map data and/or filter map data 535 (such as was described with respect to FIG. 4) may be applied to the raw image data at stage 530 to adjust the acquired image pixels in correspondence to the pixel map. At stage 540, a sub-image may be extracted from the received image. A variety of sub-image extraction techniques may be used. For example, the image may first be processed to determine a region where the eye and associated glint are located. The image may then be “zoomed” in to this region, such as by discarding pixels outside the region of interest. Alternately, the entire image area may be processed in some embodiments and/or the system may adjust the focus or zoom range of the imager element based on the detected region of interest.

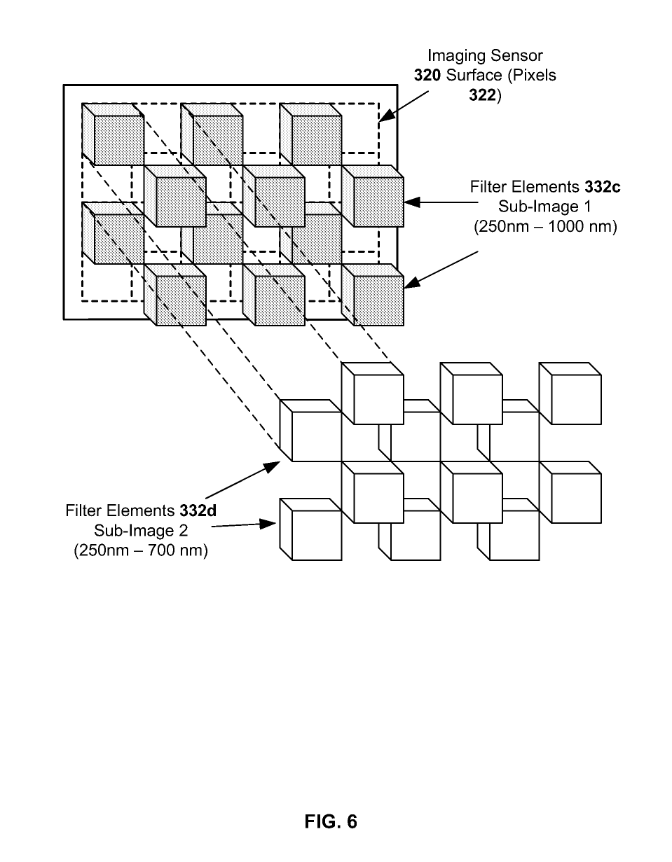

Once a particular sub-image region of interest is determined (or alternately, if the entire acquired image is used), two (or more) sub-images may be extracted from the received image as shown in FIG. 5b. The first image (image 552a) corresponds to an image including visible+IR light, with the glint 556a showing enhanced illumination relative to the rest of the eye 554a. This sub-image may be extracted from the processed image by separating received pixels based on the filter map information, with adjacent pixels assigned to their corresponding image (i.e., IR+visible pixels assigned to image 552a and visible only pixels assigned to image 552b). Although there may be some registration offset due to the pixel differences between the two images (for example, in embodiments where the pixels are alternately filtered as shown in FIG. 3a, the images 552a and 552b will be offset by one pixel), this offset will typically be small relative to the overall resolution of the sensor array 320, and may be compensated for by extrapolation, interpolation, adjusting the pixel positions, shifts, pitches, aspect ratios, sizes, gaps, shapes, and the like. The image may also be adjusted by using knowledge of the overall optical arrangement of the image capturing array. Embodiments of this implementation are further described below with respect to FIG. 6.

Because certain characteristics of the eye provide greater reflection to IR illumination (such as glints 556a), the images can be processed to separate the IR specific features as shown in image 562. For example, in a typical embodiment, the visible light only image 552b can be subtracted from the visible+IR image 552a to generate image 562, which illustrates the enhanced glint 556c. In addition to subtraction, other processing may be performed at stage 560, such as by thresholding the subtracted images (i.e., applying a threshold filter to assign pixel values above a threshold to while and pixel values below a threshold to black). Any other desired additional processing may be done at stage 570, with the processed data then stored in a memory of the sensor element and/or output at stage 580. It is noted that the processing described with respect to FIG. 5 may be performed in whole or in part in electronics on the sensor element 210, such as digital electronics 250 as shown in FIG. 2a, and/or may be performed in whole or in part in processor 40 and/or on an external computer or embedded system. The processing may be implemented on a general purpose processor and/or may be implemented with a special purpose device such as a DSP, ASIC, FPGA or other programmable device.

FIG. 6 illustrates an embodiment of a GTFA 330 filter element configuration for minimization of the relative pixel offset between two wavelength specific images, such as images 552a and 552b as shown in FIG. 5. Filter elements 332c represent filters with a passband including both visible and IR (i.e. visible+IR, wavelengths between 250 nm and 1000 nm), whereas filter elements 332d represent a visible only passband (wavelengths between 250 nm and 700 nm). Although the various filter elements 332c and 332d are illustrated as being offset from imaging sensor 320 surface, they are typically mounted in a co-planar configuration in contact or in close proximity to the surface of imaging sensor 320. A captured frame obtained from a sensor-filter configuration such as is shown in FIG. 6 will exhibit pixel-specific wavelength responses that may be processed as described with respect to FIG. 4 and FIG. 5, or via other processing methods.

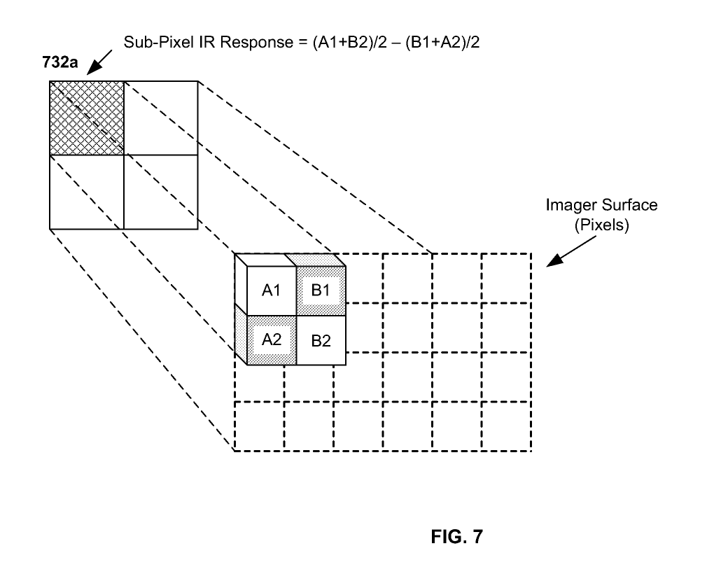

FIG. 7 illustrates another embodiment of a GTFA 330, where sub-pixel 732a is generated from 4 filtered surface pixels. As shown in FIG. 7, the value of sub-pixel 732a is a combination of value of image pixels A1, A2, B1 and B2, with the resulting sub-pixel 732a representing the equivalent of a subtracted image pixel as illustrated in FIG. 5. Such a configuration may be used to mitigate the spatial shift between sub-images as generated by a filter pattern such as is shown in FIG. 6. In this embodiment, the two sub-images (from the filter pattern configuration shown) will be offset from one another by one pixel width (a distance of, for example, approximately 5 um for a 2 megapixel image sensor). It will be apparent to one of skill in the art that the processing shown in FIG. 6 will vary for other filter array pattern configurations.

It is noted that in various embodiments the present invention may relate to processes or methods such as are described or illustrated herein and/or in the related applications. These processes are typically implemented in one or more modules comprising systems as described herein and/or in the related applications, and such modules may include computer software stored on a computer readable medium including instructions configured to be executed by one or more processors. It is further noted that, while the processes described and illustrated herein and/or in the related applications may include particular stages, it is apparent that other processes including fewer, more, or different stages than those described and shown are also within the spirit and scope of the present invention. Accordingly, the processes shown herein and in the related applications are provided for purposes of illustration, not limitation.

As noted, some embodiments of the present invention may include computer software and/or computer hardware/software combinations configured to implement one or more processes or functions associated with the present invention such as those described above and/or in the related applications. These embodiments may be in the form of modules implementing functionality in software and/or hardware software combinations. Embodiments may also take the form of a computer storage product with a computer-readable medium having computer code thereon for performing various computer-implemented operations, such as operations related to functionality as describe herein. The media and computer code may be those specially designed and constructed for the purposes of the present invention, or they may be of the kind well known and available to those having skill in the computer software arts, or they may be a combination of both.

Examples of computer-readable media within the spirit and scope of the present invention include, but are not limited to: magnetic media such as hard disks; optical media such as CD-ROMs, DVDs and holographic devices; magneto-optical media; and hardware devices that are specially configured to store and execute program code, such as programmable microcontrollers, application-specific integrated circuits (“ASICs”), programmable logic devices (“PLDs”) and ROM and RAM devices. Examples of computer code may include machine code, such as produced by a compiler, and files containing higher-level code that are executed by a computer using an interpreter. Computer code may be comprised of one or more modules executing a particular process or processes to provide useful results, and the modules may communicate with one another via means known in the art. For example, some embodiments of the invention may be implemented using assembly language, Java, C, C#, C++, or other programming languages and software development tools as are known in the art. Other embodiments of the invention may be implemented in hardwired circuitry in place of, or in combination with, machine-executable software instructions.

The description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A filtering assembly for an imaging apparatus comprising:
a filter array including a plurality of filter elements, said plurality of filter elements including a first filter element configured to filter light according to a first range of wavelengths and a second filter element configured to filter light according to a second range of wavelengths; and
a filter map, said filter map including a set of data corresponding to characteristics of ones of the plurality of filter elements.

2. The filtering assembly of claim 1 wherein the filter array is configured to facilitate adjustment of one or more characteristics of one or more of said plurality of filter elements in response to a control signal, and wherein the filter map is updated in response to said adjustment.

3. The filtering assembly of claim 1 wherein the first range of wavelengths consists of a range of visible light wavelengths and the second range of wavelengths comprises a range of infra-red (IR) light wavelengths.

4. The filtering assembly of claim 3 wherein the first range of wavelengths and the second range of wavelengths are substantially non-overlapping.

5. The filtering assembly of claim 1 wherein the characteristic of ones of the plurality of filter elements include wavelength range transmission or attenuation characteristics.

6. An imaging apparatus comprising:
An imaging sensor having a plurality of pixel elements disposed in an array, said pixel elements configured for sensing light;
a filter array optically coupled to the pixel array, said filter array including a plurality of filter elements matched to ones of a corresponding plurality of the pixel elements; and
a filter map, said filter map including a set of data corresponding to ones of the plurality of filter elements.

7. The apparatus of claim 6 further comprising a pixel map, said pixel map including a set of data corresponding to ones of the plurality of pixel elements.

8. The apparatus of claim 7 wherein the pixel map and the filter map are combined in a combination map.

9. The apparatus of claim 6 wherein a first of the plurality of filter elements is configured to filter light according to a first range of wavelengths and a second of the plurality of filter elements is configured to filter light according to a second range of wavelengths.

10. The apparatus of claim 9 wherein the first range of wavelengths consists of a range of visible light wavelengths.

11. The apparatus of claim 10 wherein the second range of wavelengths comprises a range of IR light wavelengths.

12. The apparatus of claim 9 wherein the second range of wavelengths consists of a range of IR light wavelengths.

13. The apparatus of claim 9 wherein the first range of wavelengths and the second range of wavelengths are substantially non-overlapping.

14. The apparatus of claim 6 wherein a first group of the plurality of filter elements is configured to filter light according to a first range of wavelengths and a second group of the plurality of filter elements is configured to filter light according to a second range of wavelengths.

15. The apparatus of claim 14 wherein the first group of the plurality of filter elements and the second group of the plurality of filter elements are arranged in a checkerboard pattern.

16. The apparatus of claim 14 wherein the first group of the plurality of filter elements and the second group of the plurality of filter elements are arranged in a row or column oriented pattern.

17. The apparatus of claim 14 wherein the first group of the plurality of filter elements and the second group of the plurality of filter elements are arranged in a random pattern.

18. The apparatus of claim 6 wherein the filter array is configured to adjust, in response to a control signal, one or more filtering characteristics of one or more filter elements of said plurality of filter elements.

19. The apparatus of claim 18 wherein data associated with said one or more filter elements in the filter map is updated in response to adjustment of the filter array.

20. The apparatus of claim 6 wherein the imaging sensor is a CCD sensor.

21. The apparatus of claim 6 wherein the imaging sensor is a CMOS sensor.

22. The apparatus of claim 6 wherein the filter array is mechanically coupled to the imaging sensor.

23. The apparatus of claim 6 wherein the filter array is integral with the imaging sensor.

24. The apparatus of claim 6 further comprising a memory disposed to store the filter map.

25. The apparatus of claim 24 further comprising:
a processor; and
a machine readable medium on which is stored instructions for execution on the processor to:
receive the filter map; and
store the filter map in the memory.

26. The apparatus of claim 25 wherein the instructions further include instructions to:
adjust a filter element characteristic associated with one of the plurality of filter elements of the filter array;
update the filter map; and
store the updated filter map in the memory.

27. The apparatus of claim 6 wherein the filter array includes an LCD element disposed to provide selective adjustment of one or more filter elements.

28. The apparatus of claim 6 wherein the characteristics of ones of the plurality of filter elements include wavelength range transmission or attenuation characteristics.

29. A method of processing images for gaze tracking applications comprising:
receiving a first set of data representing sensor data provided by ones of a plurality of sensor elements of a pixel array;
receiving a filter map, said filter map including data associated with characteristics of ones of a plurality of filter elements associated with corresponding ones of the plurality of sensor elements; and
generating a first processed image, said processed image generated at least in part by adjusting the first set of data based on the filter map.

30. The method of claim 29 wherein a first of the plurality of filter elements is configured to filter light according to a first range of wavelengths and a second of the plurality of filter elements is configured to filter light according to a second range of wavelengths.

31. The method of claim 30 wherein the first range of wavelengths consists of a range of visible light wavelengths and the second range of wavelengths comprises a range of IR wavelengths.

32. The method of claim 29 further comprising:
adjusting the filter characteristics of one or more of said plurality of filter elements; and
updating the filter map in response to said adjusting.
